(19) United States
(12) Patent Application Publication
(10) Pub. No.: US 2008/0031509 A1
(43) Pub. Date: Feb. 7, 2008

(54) Apparatus and method for measuring the height profile of a structured substrate

(75) Inventors: Michael Heiden, Woelfersheim (DE); Alexander Buettner, Wetzlar (DE)

Correspondence Address: DAVIDSON, DAVIDSON & KAPPEL, LLC, 485 SEVENTH AVENUE, 14TH FLOOR, NEW YORK, NY, 10018, US

(73) Assignee: Vistec Semiconductor Systems GmbH, Weilburg (DE)

(21) Appl. No.: 11/825,195

(22) Filed: Jul. 5, 2007

(30) Foreign Application Priority Data
Aug. 4, 2006 (DE) DE102006036504.6

(51) Int. Cl. G01N 21/88

(52) U.S. Cl. 382/145

(57) ABSTRACT

The invention refers to an apparatus and a method for measuring the height profile of a semiconductor substrate. In particular, the present invention refers to a confocal wafer inspection apparatus and a method of recording the height profile of an entire wafer by the use of a dispersive element, in front of which there is a slot-shaped aperture, and a two-dimensional detector.

This claims the benefit of German Patent Application No. DE 10 2006 036 504.6, filed on Aug. 4, 2006 and hereby incorporated by reference herein.

The present invention relates to an apparatus and a method for measuring the height profile of a semiconductor substrate. In particular, the present invention relates to an apparatus for measuring the height profile of a semiconductor substrate with a white-light light source defining an illumination beam path via which the white light emitted by the white-light light source impinges on the structured substrate via a beam splitter, and wherein the beam splitter directs the light reflected from the structured substrate into a detection beam path and onto a detection unit.

### BACKGROUND

A confocal wafer inspection device and method wherein a confocal chromatic height measuring device is combined with a translation stage, a computer and two cameras, is known from PCT Publication WO 03/036227 A1.

U.S. Patent Application No. 2005/0030528 A1 discloses a confocal chromatic wafer inspection device and method on the basis of a confocal height measuring device for the high-precision height measurement of three dimensional objects on microelectronic wafer chips. The apparatus provides a translation stage, a computer, a microscope and two cameras as well as the confocal height measuring device providing a point-shaped light source and a spatial filter.

European Patent EP 0 916 981 B1 discloses a confocal spectroscopy system and a method with a wavelength-programmable light source.

From U.S. Pat. No. 6,167,148, an improved wafer inspection device and method are known, wherein a white-light image of an entire wafer surface is obtained.

PCT Publication WO 01/51885 A1 discloses a height measuring apparatus for bumps (microscopic metal balls) on wafers, and a method for measuring and directly comparing bump heights on wafers on the basis of the projection of a circular light source onto a bump from different projection angles.

### SUMMARY OF THE INVENTION

Drawbacks of the state of the art: with these inventions, the surface is scanned with a point shape. This results in limited scanning speeds and a limitation on wafer throughput with surface measurements of the entire wafer.

]An object of the present invention is to provide an apparatus and a method allowing the height profile of a structured sample to be measured rapidly, precisely and cheaply.

The present invention provides an apparatus for measuring the height profile of a semiconductor substrate with a white-light light source defining an illumination beam path via which the white light emitted by the white-light light source impinges on the structured substrate via a beam splitter. The beam splitter directs the light reflected from the structured substrate into a detection beam path and onto a detection unit: A dispersive element is arranged in the detection beam path in front of a slot-shaped aperture and wherein the detection unit is a two-dimensional detector.

The present invention also provides a method for recording the height profile of a structured substrate, comprising the steps of:
illuminating the semiconductor substrate with white light;
projecting the white light reflected from the semiconductor substrate onto a slot-shaped aperture;
spectrally dispersing the white light passing through the slot-shaped aperture with the aid of a dispersive element, and
detecting the individual spectral components of the dispersed light with a two-dimensional detector, wherein different locations of the spectral components on the semiconductor substrate are obtained by the two-dimensional detector.

The advantages achieved with the invention include in particular that with the recording being carried out on a line-by-line basis, the height profile of a great number of adjacent points can be realized simultaneously, which allows more rapid detection than in the case of point-by-point scanning. Further, the height profile of an entire wafer can be rapidly recorded. The use of a two-dimensional detector additionally increases the detection speed and also facilitates a cost-effective and precise height measurement.

It is particularly advantageous for the lenses arranged in the illumination beam path not to be corrected with respect to their chromatic aberration, so that the light of the source in different wavelengths is imaged onto different planes. If the light reflected from the surface is projected onto a slot-shaped aperture via a beam splitter, only light of one wavelength passes from each point on the surface into the detector. The light of other wavelengths is not focused in the slot plane and therefore greatly attenuated. Since the wavelength passing into the detector is a function of each structural height of the substrate a wavelength measurement allows a conclusion to be drawn on the height at each location on the substrate.

In one particularly advantageous embodiment of the invention, an illumination spot in the illumination beam path impinges on the structured substrate and has a diameter greater than the length of the slot-shaped aperture. The length of the slot-shaped aperture should be equal to or smaller than the diameter of the structured substrate.

A means is also provided for causing a relative movement between the structured substrate and the slot-shaped aperture. In one exemplary embodiment, an XY scanning stage is used herefor, on which the substrate is fixedly supported. By having the XY scanning stage perform corresponding raster-scan movements, the height profile of the entire substrate can be quickly detected. The semiconductor substrate can be a structured or unstructured wafer, a flat panel display or a mask for semiconductor manufacture. A dispersive element is arranged for spectral dispersion, wherein the latter can be a one-dimensional optical grid or a prism. Herein a one-dimensional grid is a plurality of optical elements arranged in parallel, such as microscopic prisms or metal strips having a periodicity extending in only one direction.

For detecting the impinging light, a two-dimensional detector is used, such as a CCD chip or a CMOS chip.

The present invention also provides a method for recording the height profile of a structured substrate. Herein, the structured substrate is first illuminated using an illumination spot of white light. Then the white light reflected from the semiconductor substrate is projected onto a slot-shaped aperture and spectrally dispersed by means of a dispersive element. The individual spectral components of the dispersed light are detected using a two-dimensional detector, wherein different locations of the spectral components on the structured substrate are obtained with the two-dimensional detector.

In a preferred embodiment, the length of the slot-shaped aperture is smaller than the diameter of the structured substrate. The illumination spot is configured in such a way that it floods the slot-shaped aperture with light. The size of the illumination spot is such that at least two scanning movements allow the entire surface of the structured substrate to be detected.

The dispersed light is detected by a CCD chip or a CMOS chip, and the different locations of the spectral components on the two-dimensional detector are converted into height information of the structures provided on the semiconductor substrate. The structured substrate is preferably a wafer, a flat panel display or a mask for semiconductor manufacture.

### BRIEF DESCRIPTION OF THE DRAWINGS

The drawings schematically show the subject matter of the present invention which will be described with reference to the accompanying drawings, in which:

FIG. 1 is a schematic representation of the apparatus for height measurement of a structured substrate by means of the confocal principle according to the state of the art;

FIG. 2a is a schematic representation of the apparatus according to the present invention for scanning the surface of a semiconductor substrate on a line-by-line basis, wherein the slot-shaped aperture is oriented in the Y direction;

FIG. 2b is a schematic representation of the apparatus of the present invention for scanning the surface of a semiconductor substrate on a line-by-line basis, wherein the slot-shaped aperture is normal to the X direction;

FIG. 3a is a schematic representation of the two-dimensional detector used for height measurement, for example a CCD chip or a CMOS chip, wherein the different wavelengths are detected at different locations x. The wavelength spectrum for different points in the X direction is plotted in the Y direction.

FIG. 3b is a schematic representation of a height profile, wherein the height of the wafer at location x can be derived from the y position of the intensity maximum;

FIG. 4 is a schematic representation of the arrangement and relative movement of the semiconductor substrate, the white-light illumination and the illumination spot and the slot-shaped aperture, respectively;

FIG. 5a is a schematic representation of three structures having different heights on a semiconductor substrate, wherein each height is simultaneously detected by using a white-light illumination spot and the slot-shaped aperture; and

FIG. 5b is a schematic representation of a plan view of three structures having different heights on a semiconductor substrate.

### DETAILED DESCRIPTION

Equivalent features and elements in different views of the drawings have been designated with the same reference numerals for clarity.

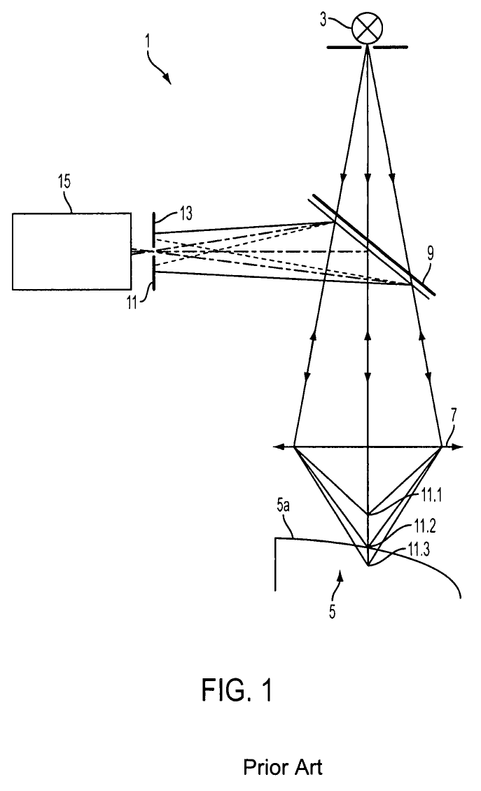

FIG. 1 shows a schematic representation of an apparatus for the height measurement of a structured substrate by means of the confocal principle according to the state of the art (source: SPIE's 46^{th} Annual Meeting, San Diego, USA, 2-3 Aug. 2001, Paper by the Stil Firm). A point-shaped white-light source 3 is projected onto surface 5a of substrate 5. Projecting lens 7 has strong chromatic aberrations, i.e. the light of the source having different wavelengths, shown as 11.1, 11.2 and 11.3, is imaged onto different planes. If the light reflected from surface 5a of substrate 5 is imaged, via a beam splitter 9, onto a point-shaped aperture 30, having its distance held constant to beam splitter 9, light of only one wavelength 11.2 passes into spectrometer 15. The light from other wavelengths 11.1 and 11.3 is not focused on a point of surface 5a of structured substrate 5 and is therefore greatly attenuated and impinges on point-shaped aperture 13 as a light spot. When the chromatic aberrations of the projecting lens 7 are known, the current height of substrate 5 can be derived by a measurement in spectrometer 15. It must be noted, however, that only those wavelengths which fulfill optimum focus conditions (11.2) are imaged in the spectrometer with the greatest intensity. The current height of the substrate can therefore be determined from an intensity measurement of each wavelength.

Since the wavelength correlates with the height on the substrate, the structural height can be concluded from a wavelength measurement. To achieve this, the light is spectrally split up and imaged on a CCD row. Each dot on the row therefore corresponds to a certain height of the structure on the substrate.

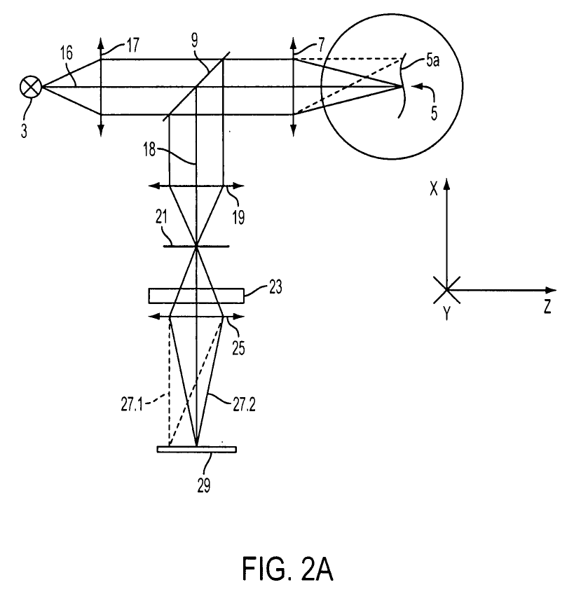

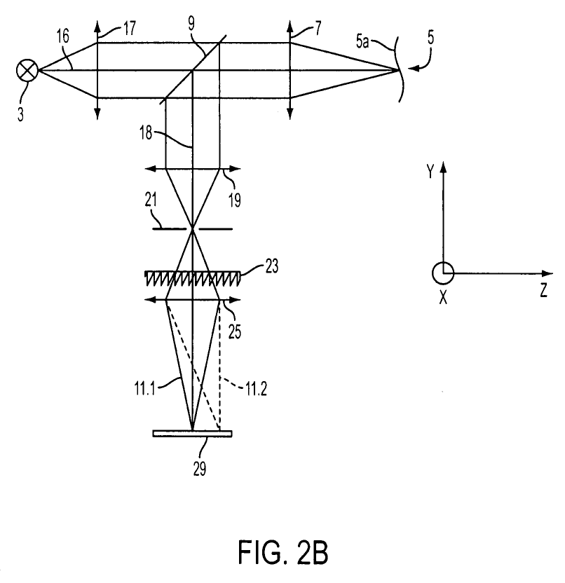

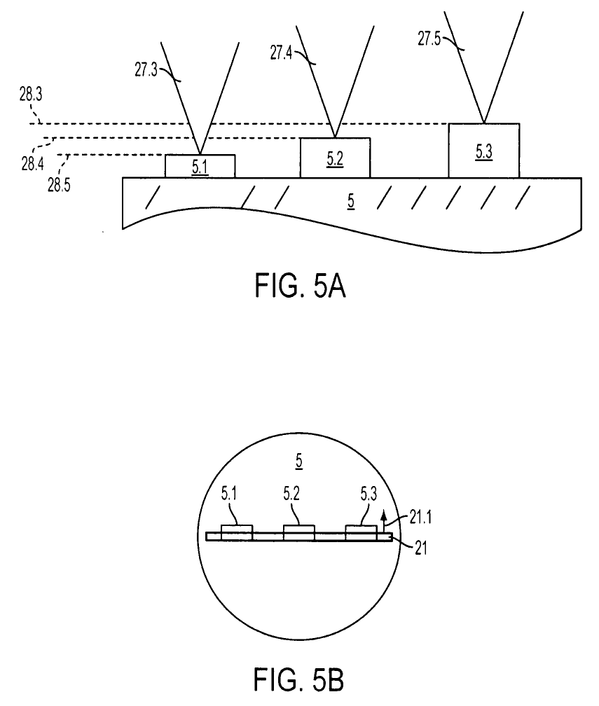

FIG. 2a is a schematic representation of the apparatus according to the present invention for measuring the height profile. The light of a white-light source 3 is parallelized with the aid of a lens system 17 in the illumination beam path 16 and projected onto surface 5a of a substrate 5 preferably in the form of a slot-shaped illumination spot via a beam splitter 9 and a focusing lens system 7. Lens system 7 has a strong chromatic aberration, so that light of different wavelengths is imaged onto different planes of substrate 5. A precise description of the focused planes will be given with reference to FIG. 5. Beam splitter 9 directs the light reflected from surface 5a of substrate 5 in detection beam path 18 with lens system 19 first onto slot-shaped aperture 21 and then onto detector 29 via lens system 25, wherein aperture 21 only passes light beams of wavelengths fulfilling the focus conditions of a line-shaped section of surface 5a (cf. FIGS. 5a, 5b). The light emitted by slot-shaped aperture 21 is directed via a grid 23 normal to the X direction, and detected by a two-dimensional detector 29, wherein different locations of the spectral components on the substrate 5 are obtained even though grid 23 is still a dispersive element. Since only light of one wavelength passes grid 23 in this case, there is no spectral dispersion. Slot-shaped aperture 21 is oriented in the Y direction in the present figure, is therefore directed out of the paper plane, so that only the aperture frame is visible in the present figure. 27.1 and 27.2 designate two light beams of different locations of equal height on a line section of surface Sa of structured substrate 5 or in two-dimensional detector 9. A line of a plurality of dots on planes of the same height and the same wavelength on the detector is therefore imaged.

FIG. 2b is another schematic representation of the apparatus according to the present invention for measuring the height profile. 11.1 and 11.2 in FIG. 2b designate light beams of different wavelengths or colors of different locations in different planes on surface 5a of substrate 5, which fulfill the focus conditions. FIG. 2b is rotated by 90° in the X direction with respect to FIG. 2a in order to illustrate the correlation between the wavelength or color and a location illuminated by the white-light spot on structured substrate 5.

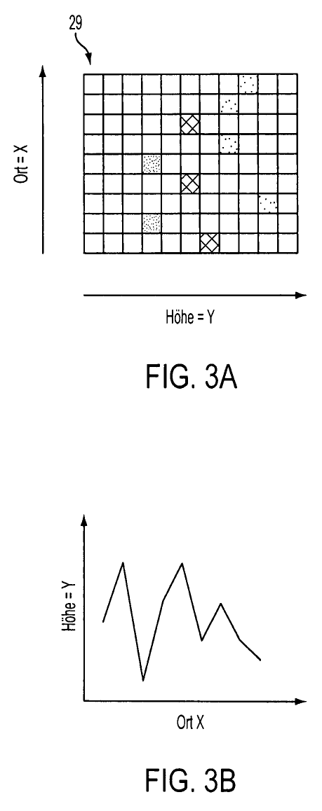

The light emitted by white-light source 3 is parallelized with a lens system 17 in illumination beam path 16 and projected onto surface 5a of a structured substrate 5 preferably in the form of a slot-shaped illumination spot via a beam splitter 9 and a focusing lens system 7. Lens system 7 has strong chromatic aberration, so that light of different wavelengths is imaged onto different planes of substrate 5. A precise description of the focused planes will be given with reference to FIGS. 5a and 5b. Beam splitter 9 first directs the light reflected from surface 5a of substrate 5 in detection beam path 18 with lens system 19 onto slot-shaped aperture 21 and grid 23, and then onto detector 29 via lens system 25, wherein aperture 21 only passes light beams of wavelengths which fulfill the focus conditions of a line-shaped section of surface 5a (cf. FIGS. 5a and 5b). The light emitted by slot-shaped aperture 21 is spectrally dispersed over a grid 23 arranged in the X direction and detected with a two-dimensional detector 29, wherein different locations of the spectral components on the structured substrate are obtained. A schematic representation of the detector is shown in FIG. 3a.

In contrast to the prior art, as shown in FIG. 1, wherein only one wavelength reaches spectrometer 15 due to the use of a point-shaped white-light source 3 and a point-shaped aperture 13, the use of a spot-shaped light source, the slot-shaped aperture and the one-dimensional grid result in a plurality of wavelengths impinging on the two-dimensional detector simultaneously. This is how a shorter recording time is needed for the same surface area.

FIG. 3a is a schematic representation of two-dimensional detector 29 used in FIG. 2b for measuring, such as a CCD chip, in which the different wavelengths are split up in the Y direction and are registered at different locations. In the Y direction the wavelength spectrum blue, green and red is plotted for different points on the substrate surface in the X direction. The light impinges on the CCD chip on a line-by-line basis.

FIG. 3b shows how the Y position of the intensity maximum can be used as an indication of the height of the structured substrate at location X. This representation of the substrate profile is obtained by rotating the representation in FIG. 3a by 90° counter clockwise. There are two height maxima shown on the height profile, caused by the reflection of light of a blue wavelength, and an absolute height minimum on the surface caused by the reflection of light of the red wavelength. Light of a green wavelength indicates structures of mean height.

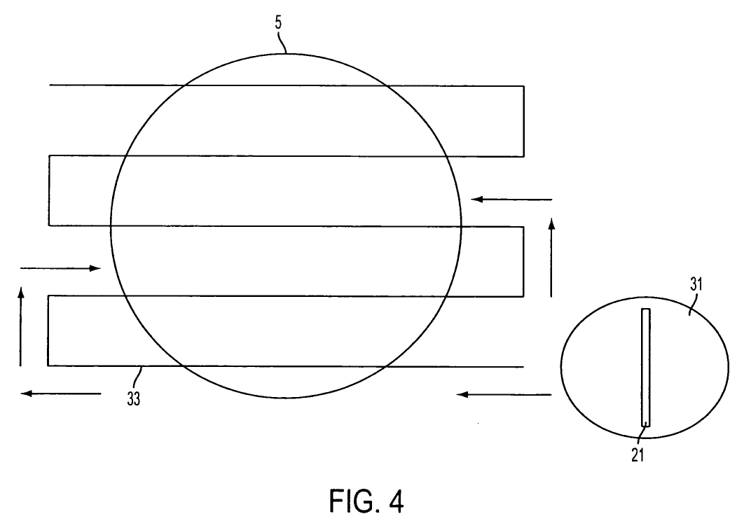

FIG. 4 is a schematic representation of the inventive arrangement and relative movement 33 of substrate 5, white-light illumination or illumination spot 31 and slot-shaped aperture 21. In an advantageous embodiment of the present invention, an illumination spot 31 having a diameter greater than the length of the slot-shaped aperture in the illumination beam path impinges on substrate 5. Substrate 5 rests on an XY scanning stage which, by means of raster-scan movements 33, ensures that the entire substrate 5 is illuminated successively and therefore the entire height profile of substrate 5 is detected. In a preferred embodiment, illumination spot 31 further has the shape of a line corresponding to the slot-shaped aperture.

FIG. 5a is a schematic representation of three structures having different heights, wherein the respective heights are detected on a line through the use of a white-light illumination spot providing a plurality of wavelengths 27.3, 27.4 and 27.5. Wavelengths 27.3, 27.4 and 27.5 are imaged on planes 28.3, 28.4 and 28.5 due to chromatic aberrations and fulfill the focus conditions of each structural height of 5.1, 5.2 and 5.3, and are recorded in correspondence to FIG. 3a.

FIG. 5b is another schematic representation of structures on a substrate 5 scanned by means of a scanning movement 21.1 relative to slot-shaped aperture 21. Each of the 3 structures 5.1, 5.2 and 5.3 with different heights are covered by the aperture, so that their measurements can be taken simultaneously.

The arrangements and methods shown are in particular for the so-called macro inspection of wafers, they are, however, not limited in this respect.

What is claimed is:

1. An apparatus for measuring the height profile of a structured semiconductor substrate comprising:
a detection unit;
a beam splitter;
a white-light light source defining an illumination beam path, white light emitted by the white-light light source impinging via the illumination beam path on the structured semiconductor substrate via the beam splitter;
the beam splitter directing the light reflected from the structured semiconductor substrate into a detection beam path and onto the detection unit; and
a dispersive element arranged in the detection beam path in front of a slot-shaped aperture, the detection unit being a two-dimensional detector.

2. The apparatus according to claim 1 further comprising lenses arranged in the illumination beam path, the lenses being uncorrected with respect to a chromatic aberration.

3. The apparatus according to claim 1 wherein, in the illumination beam path, an illumination spot with a diameter greater than the length of the slot-shaped aperture impinges on the structured substrate.

4. The apparatus according to claim 3 wherein the illumination spot corresponds to the form of the slot-shaped aperture.

5. The apparatus according to claim 1 wherein the length of the slot-shaped aperture is shorter than the diameter of the structured substrate.

6. The apparatus according to claim 1 wherein the slot shaped aperture is movable with respect to the structured substrate.

7. The apparatus according to claim 1 wherein the dispersive element is a one-dimensional optical grid or a prism.

8. The apparatus according to claim 1 wherein the two-dimensional detector is a CCD chip or a CMOS chip.

9. An apparatus for measuring the height profile of substrate, the substrate being a structured or unstructured wafer, a flat panel display or a mask for semiconductor manufacture, the apparatus comprising:
a detection unit;
a beam splitter;
a white-light light source defining an illumination beam path, white light emitted by the white-light light source impinging via the illumination beam path on the substrate via the beam splitter;
the beam splitter directing the light reflected from the structured semiconductor substrate into a detection beam path and onto the detection unit; and
a dispersive element arranged in the detection beam path in front of a slot-shaped aperture, the detection unit being a two-dimensional detector.

10. A method for recording the height profile of a structured semiconductor substrate comprising the steps of:
illuminating the structured semiconductor substrate with white light,
projecting white light reflected from the semiconductor substrate onto a slot-shaped aperture,
spectrally dispersing the white light passing through the slot-shaped aperture with the aid of a dispersive element, and
detecting individual spectral components of the dispersed light with a two-dimensional detector, different locations of the spectral components on the structured semiconductor substrate being obtained by the two-dimensional detector.

11. The method according to claim 10 wherein lenses arranged in the illumination beam path are not corrected with respect to their chromatic aberration.

12. The method according to claim 10 wherein the illumination spot is chosen to correspond to the form of the slot-shaped aperture.

13. The method according to claim 10 wherein, in the illumination beam path, an illumination spot of white light having a diameter greater than the length of the slot-shaped aperture impinges on the semiconductor substrate.

14. The method according to claim 10 wherein the length of the slot-shaped aperture is chosen so that it is shorter than the diameter of the semiconductor substrate.

15. The method according to claim 10 wherein a relative movement between the structured substrate and the slot-shaped aperture is produced to thus detect the entire surface of the semiconductor substrate.

16. The method according to claim 10 wherein the dispersive element for spectral dispersion is a one-dimensional optical grid or a prism.

17. The method according to claim 10 wherein the dispersed light is detected by a CCD chip or a CMOS chip.

18. The method according to claim 10 wherein different locations of the spectral components on the two-dimensional detector are converted to height information of the structures present on the semiconductor substrate.

19. A method for recording the height profile of a substrate, the substrate being a structured or unstructured wafer, a flat panel display or a mask for semiconductor manufacture, the method comprising the steps of:
illuminating the structured semiconductor substrate with white light,
projecting white light reflected from the semiconductor substrate onto a slot-shaped aperture,
spectrally dispersing the white light passing through the slot-shaped aperture with the aid of a dispersive element, and
detecting individual spectral components of the dispersed light with a two-dimensional detector, different locations of the spectral components on the structured semiconductor substrate being obtained by the two-dimensional detector.
